(19) United States
(12) Patent Application Publication
(10) Pub. No.: US 2012/0228482 A1
(43) Pub. Date: Sep. 13, 2012

(54) SYSTEMS AND METHODS FOR SENSING LIGHT

(75) Inventor: Andy Lai Lin, Parsippany, NJ (US)

(73) Assignee: CANON KABUSHIKI KAISHA, Tokyo (JP)

(21) Appl. No.: 13/043,769

(22) Filed: Mar. 9, 2011

(51) Int. Cl. G02B 26/00; H01J 3/16

(52) U.S. Cl. 250/216; 359/291

(57) ABSTRACT

A device for sensing light comprises a light sensor, one or more intermediate mirrors, a micromirror array including a plurality of independently positionable micromirrors, wherein a first micromirror in the micromirror array is positionable in a first position such that light reflected by the first micromirror while in the first position is reflected toward a first region on one of the one or more intermediate mirrors, wherein the light reflected toward the first region on one of the one or more intermediate mirrors is further reflected to the light sensor, and a lens configured to direct light toward the micromirror array.

### BACKGROUND

1. Field of the Disclosure

The present disclosure relates generally to sensing light.

2. Description of the Related Art

A typical camera has a single focal length and thus a single focal point and focal plane. Accordingly, only objects within the focal plane will appear to be in focus in an image. Though objects within the depth of field of the focal plane may be acceptably sharp, objects in the image will be increasingly unfocused in proportion to their distance from the focal plane. A photographer can take multiple images of a scene, each with a different focal plane—and thus region of focus—and later combine the images to produce an image that has a larger region of focus, but this technique requires more time to capture the additional images, storage space to store them until they can be combined, and computational power to combine the images.

Light field cameras record the direction of light as well as the intensity of the light at each pixel location. Light field images allow the images to be refocused after they are captured and the data they capture can be used to produce an all-in-focus image. However, light field cameras capture large amounts of data, increasing storage requirements, and reconstructing and refocusing images from the captured light fields is more computationally expensive. Furthermore, light field cameras sacrifice image resolution to capture light direction.

### SUMMARY

In one embodiment, a device for sensing light comprises a light sensor, one or more intermediate mirrors, a micromirror array including a plurality of independently positionable micromirrors, wherein a first micromirror in the micromirror array is positionable in a first position such that light reflected by the first micromirror while in the first position is reflected toward a first region on one of the one or more intermediate mirrors, wherein the light reflected toward the first region on one of the one or more intermediate mirrors is further reflected to the light sensor, and a lens configured to direct light toward the micromirror array.

In one embodiment, a method for sensing light comprises positioning a first micromirror in an array of micromirrors such that light reflected from the first micromirror travels from the first micromirror to a first intermediate mirror to a light sensor, and positioning a second micromirror in the array of micromirrors such that light reflected from the second micromirror travels a second path from the second micromirror to a second intermediate mirror to the light sensor.

In one embodiment, a device for sensing light comprises a light sensor, one or more intermediate surfaces, wherein an intermediate surface includes a reflective surface, and a plurality of micromirrors, each micromirror including a reflective surface and being positionable in at least a first position and a second position, wherein in the first position light reflected by a first micromirror travels a first path from the first micromirror to a first region on the light sensor, and wherein in the second position light reflected by the first micromirror travels a second path from the first micromirror to a first intermediate surface to the first region on the light sensor.

### BRIEF DESCRIPTION OF THE DRAWINGS

FIG. 1 illustrates an embodiment of a device for sensing light.

FIG. 2 illustrates an embodiment of a system for varying the distance traveled by rays of light.

FIG. 3 illustrates an embodiment of a system for varying the distance traveled by rays of light.

FIG. 4 illustrates an embodiment of a system for varying the distance traveled by rays of light.

FIG. 5 illustrates an embodiment of a system for varying the distance traveled by rays of light.

FIG. 6 is a block diagram that illustrates an embodiment of a method for positioning micromirrors.

FIG. 7 is a block diagram that illustrates an embodiment of a method for positioning micromirrors.

FIG. 8 is a block diagram that illustrates an embodiment of a method for positioning micromirrors.

### DETAILED DESCRIPTION OF CERTAIN EMBODIMENTS

The following description is of certain illustrative embodiments, and the disclosure is not limited to these embodiments, but includes alternatives, equivalents, and modifications such as are included within the scope of the claims. Additionally, the illustrative embodiments may include several novel features, and a particular feature may not be essential to practice the systems and methods described herein.

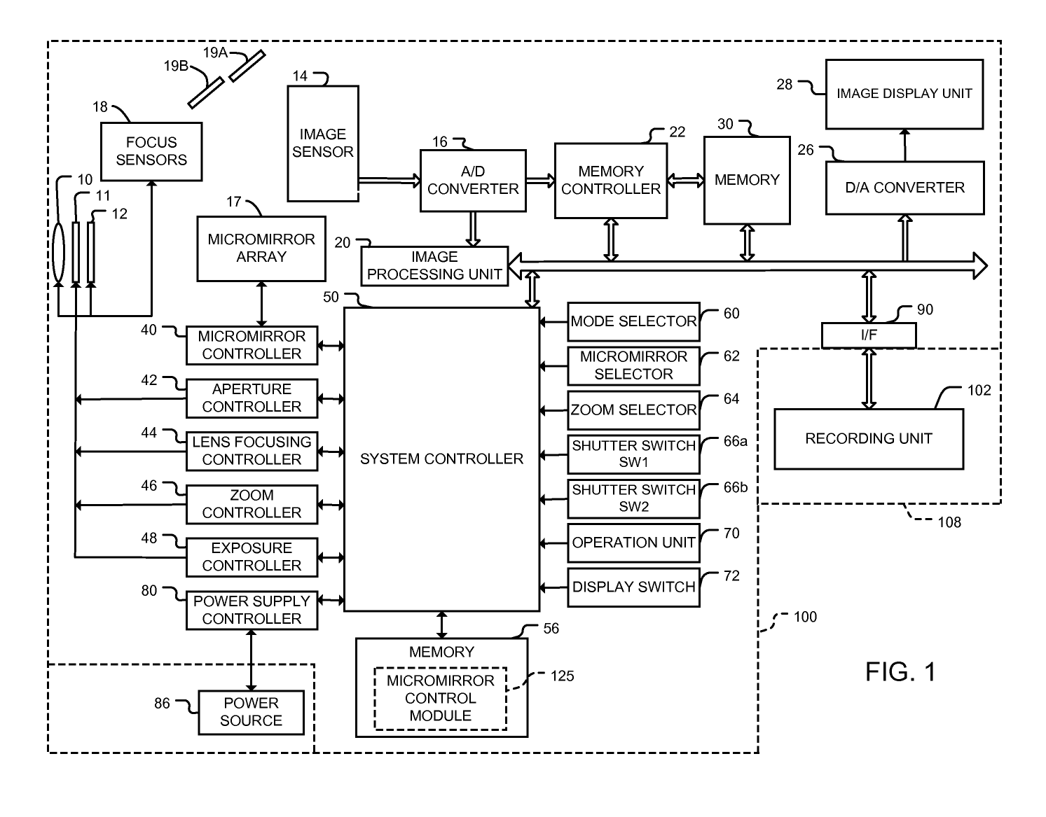

FIG. 1 is a block diagram illustrating an embodiment a device for sensing light 100 (also referred to herein as “device 100”). The device 100 includes a lens 10 (which may include a plurality of lenses), an aperture 11 (which may include a plurality of apertures), a shutter 12, and an image sensor 14 that converts incident electromagnetic radiation (e.g., an optical image) into an electrical signal. Furthermore, in other embodiments the lens 10, the aperture 11, and the shutter 12 may be arranged differently than is shown in the embodiment of FIG. 1.

Electromagnetic radiation (also referred to herein as “light”) reflected from a scene (e.g., an object in the scene) passes through the lens 10, the aperture 11, and the shutter 12, when open, and forms an optical image on an image sensing surface of the image sensor 14. The image sensor 14 converts the optical image to analog image signals and outputs the signals to an ND converter 16. The A/D converter 16 converts the analog image signals to digital image signals. The image sensor 14 can detect light in the spectrum visible to the human eye and/or in the spectrum that the human eye cannot detect (e.g., infrared, x-ray, ultraviolet, gamma rays). In some embodiments, the image sensor 14 can detect light fields, including 4 dimensional fields.

The device 100 also includes a micromirror array 17 and intermediate mirrors 19A, 19B. The micromirror array 17 includes a plurality of micromirrors, each of which has a reflective surface. Micromirrors or groups of micromirrors may be independently positionable, and each micromirror may be rotatable along 2 axes and/or translatable along one or more axes. A micromirror may be formed in one of many shapes, including triangular shapes, rectangular shapes, square shapes, circular shapes, hexagonal shapes, etc., and may have a flat or curved surface. The micromirror array 17 may be a semiconductor device. The micromirror array 17 is configured to adjust the respective positions of individual micromirrors or groups of micromirrors according to control signals it receives.

The intermediate mirrors 19A, 19B reflect light received from the micromirror array toward the image sensor 14. The intermediate mirrors 19A, 19B are positioned so that light traveling a path from the micromirror array 17 to intermediate mirror 19A to the image sensor 14 travels a different distance than light traveling a path from the micromirror array 17 to intermediate mirror 19B to the image sensor. The micromirrors may each have a predetermined position corresponding to each intermediate mirror 19A, 19B, such that light reflected from a particular micromirror while in a predetermined position is directed to a location on the image sensor 14 that corresponds to the location of the particular micromirror in the micromirror array 17 after being reflected by the intermediate mirror (19A or 19B) that corresponds to the predetermined position. For example, a micromirror approximately in the center of the micromirror array 17 may have a predetermined position that corresponds to intermediate mirror 19A, and, while in the predetermined position, light reflected from the micromirror in the center is again reflected by the intermediate mirror 19A approximately toward the center of the image sensor 14.

The micromirror controller 40 controls the positions of the micromirrors. The micromirror controller 40 receives signals from the system controller 50, converts them into micromirror control signals, and sends the micromirror control signals to the micromirror array 17. The micromirror controller 40 may determine the predetermined positions of respective micromirrors (e.g., by accessing a lookup table that stores the respective positions) and the control signals may indicate the position adjustments the micromirror array 17 needs to perform to position the micromirrors in the predetermined positions. Some embodiments do not include the micromirror controller 40, and its functionality is implemented by the system controller 50 and/or the micromirror array 17.

The focus sensors 18 detect incident light and generate signals that indicate how focused the incident light is and/or a phase difference of the incident light. Depending on the embodiment, the focus sensors 18 include one or more of phase detection sensors (e.g., area sensors, cross-type sensors, photosensitive strips) and contrast measurement sensors. Also, the image sensor 14 may be used to perform contrast measurements.

The device 100 also includes an image processing unit 20, which applies resize processing, such as predetermined interpolation and reduction, and color conversion processing to data from the ND converter 16 or data from a memory 30. The image processing unit 20 performs predetermined arithmetic operations using the captured image data, and the device 100 performs exposure control and ranging control based on the obtained arithmetic result. The device 100 can perform TTL (through-the-lens) AF (auto focus) processing, AE (auto exposure) processing, and EF (flash pre-emission) processing. The image processing unit 20 further performs TTL AWB (auto white balance) operations based on the obtained arithmetic result.

Output data from the ND converter 16 is written in the memory 30 via the image processing unit 20 and/or memory controller 22. The memory 30 stores image data that is captured by the image sensor 14 and converted into digital data by the ND converter 16. The memory 30 may store images (e.g., still photos, videos) and other data, for example metadata and file headers for captured images. The memory 30 may also serve as an image display memory. A D/A converter 26 converts digital data into an analog signal and supplies that analog signal to an image display unit 28. The image display unit 28 presents images according to the analog signal from the D/A converter 26 on a display (e.g., an LCD display, and LED display, an OLED display).

An exposure controller 48 controls the shutter 12. The exposure controller 48 may also have a flash exposure compensation function that links with a flash (e.g., a flash emission device). An aperture controller 42 controls the size of the aperture 11. A lens focusing controller 44 controls the focus of the lens 10, and a zoom controller 46 controls the angle of view of the lens 10. The exposure controller 48, aperture controller 42, lens focusing controller 44, and zoom controller 46 may each partially control the lens 10, aperture 11, and shutter 12, and may also communicate with each other to determine settings for the lens 10, aperture 11, and shutter 12.

A memory 56 is a readable and writable memory, and may include, for example, an EEPROM, a semiconductor memory (e.g., a solid state drive, SRAM, DRAM), a magnetic disc, etc. The memory 56 may store computer-executable programs and data for operation of a system controller 50. The system controller 50 includes one or more processors (e.g., microprocessors) and reads and performs computer-executable instructions, such as instructions stored in the memory 56. Note that the computer-executable instructions may include those for the performance of various methods described herein. The memory 56 is an example of a non-transitory computer-readable memory medium that stores computer-executable instructions, as described herein.

The memory 56 includes a micromirror control module 125. A module includes instructions that may be executed by the device 100 to cause the device 100 to perform certain operations, though for ease of description a module may be described as performing the operations. Modules may include logic and/or computer readable instructions and may be implemented in software, firmware, and/or hardware. In other embodiments, the device 100 may include more modules, or the module may be divided into more modules. The instructions in the micromirror control module 125 may be executed to cause the device 100 to position the micromirrors in the array of micromirrors and/or perform the methods described herein.

Modules may be implemented in any applicable computer-readable storage medium including, for example, a floppy disk, a hard disk, an optical disc (e.g., a CD, a DVD, a Blu-ray), a magneto-optical disk, a magnetic tape, semiconductor memory (e.g., a non-volatile memory card, flash memory, SRAM, DRAM), that can be employed as a storage medium for supplying the computer-executable instructions. Furthermore, when the computer-executable instructions are executed by one or more devices, an operating system executing on the one or more devices may carry out part or all of the actual processing that realizes the operations of the instructions.

The device 100 also includes a mode selector 60 that sets the operation mode of the device 100 to still image recording mode, movie recording mode, playback mode, master mode, slave mode, etc. The shutter switch SW1 66a, which may be activated in the middle of operation (half stroke) of a shutter button, generates a first shutter switch signal. Also, the shutter switch SW2 66b, which may be activated upon a full stroke of the shutter button, generates a second shutter switch signal. In other embodiments, the shutter switches SW1 66a and SW2 66b may be activated by different controls. The system controller 50 may start the operations of the AF (auto focus) processing, AE (auto exposure) processing, AWB (auto white balance) processing, EF (flash pre-emission) processing, and the like in response to the first shutter switch signal. Also, in response to the second shutter switch signal, the system controller 50 may perform and/or initiate a series of operations, including the following: reading image signals from the image sensor 14, converting image signals into image data by the ND converter 16, processing of image data by the image processor 20, writing image data to the memory 30, reading image data from the memory 30, compression of the image data, and writing data to the recording medium 108.

A zoom selector 64 may be operated by a user to change the angle of view (zooming magnification or shooting magnification). The zoom selector 64 may include a slide-type member, a lever, and/or a switch. The display switch 72 activates and deactivates the image display unit 28.

A micromirror selector 62 selects an operation mode for the micromirror array 17. The modes may include a static mode, in which the micromirrors are not adjusted and reflect light to a predetermined location (e.g., an intermediate mirror 19A, 19B or the image sensor 14), and one or more dynamic modes, in which the respective positions of the micromirrors are dynamically adjusted.

The operation unit 70 may include various buttons, touch panels and so on. In one embodiment, the operation unit 70 includes a menu button, a set button, a macro selection button, a multi-image reproduction/repaging button, a single-shot/serial shot/self-timer selection button, a forward (+) menu selection button, a backward (−) menu selection button, and the like. The operation unit 70 may also set and change the flash operation mode. The settable modes include auto, flash-on, red-eye reduction auto, and flash-on (red-eye reduction). The operation unit 70 may be used to select a storage format for the captured image information, including JPEG (Joint Photographic Expert Group) and RAW formats. The operation unit 70 may set the device 100 to a plural-image shooting mode, wherein data from a plurality of images data can be recorded in response to a single shooting instruction by a user. This may include auto bracketing, wherein one or more shooting parameters (e.g., white balance, exposure) are altered in each of the images.

A power supply controller 80 detects the existence/absence of a power source, the type of the power source, and a remaining battery power level, and supplies a necessary voltage to other components as required. A power source 86 includes a battery, such as an alkaline battery, a lithium battery, a NiCd battery, a NiMH battery, and an Li battery, an AC adapter, and the like.

The recording media 108 includes a recording unit 102 that is configured with one or more computer-readable media, including, for example, semiconductor memory, a magnetic disk, an optical discs, etc. The device 100 and the recording media 108 communicate via an interface 90. Although the illustrated embodiment includes one interface 90 and one recording media 108, other embodiments may include additional recording media and interfaces.

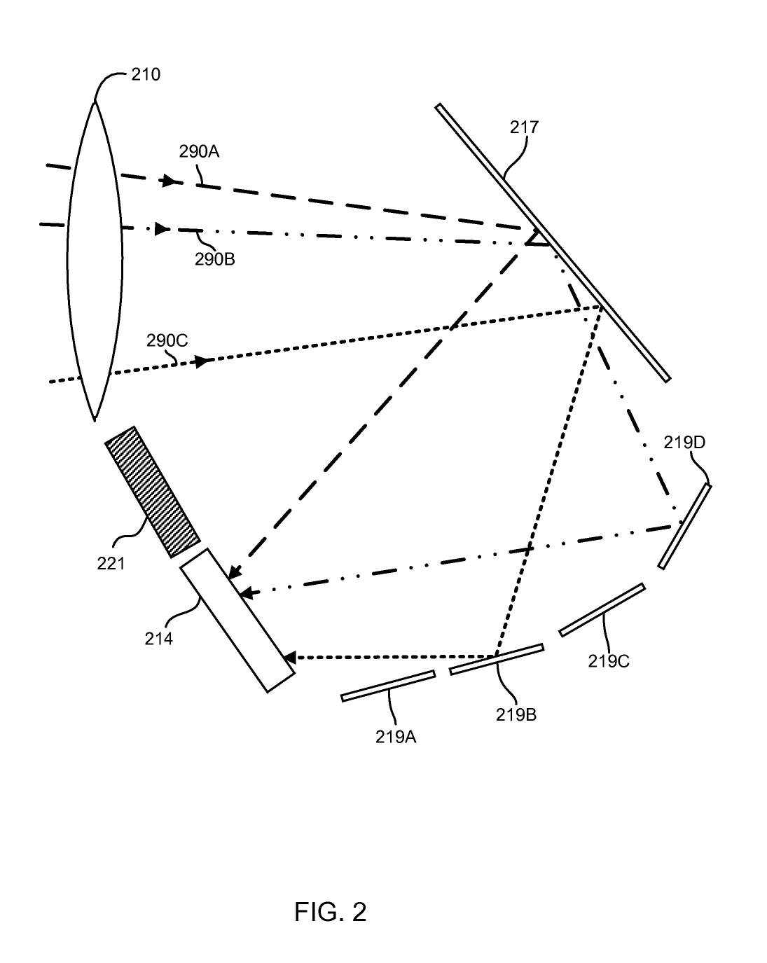

FIG. 2 illustrates an embodiment of a system for varying the distance traveled by rays of light. The system includes a lens 210, a micromirror array 217, an image sensor 214, intermediate mirrors 219A-D, and a focus sensor 221. In this embodiment, the image sensor 214 is positioned on the same side of the lens 210 as the intermediate mirrors 219A-D. The micromirrors in the micromirror array 217 can each be positioned independently of one another to reflect light toward one or more of the intermediate mirrors such that the light is reflected from the intermediate mirror(s) to the image sensor 14. Additionally, the micromirrors can be positioned to reflect light directly toward the image sensor 14 and the focus sensor 221, and the micromirrors may be positioned in groups of two or more micromirrors.

FIG. 2 illustrates examples of light rays 290A, 290B, 290C traveling different respective distances from the lens 210 to the image sensor 214. Light ray 290A passes through the lens and is reflected from the micromirror array 217 directly to the image sensor 214. Light ray 290B passes through the lens 210, is reflected from the micromirror array 217 toward intermediate mirror 2198, and is reflected again toward the image sensor 214. Light ray 290C passes through the lens 210, is reflected from the micromirror array 217 toward intermediate mirror 219D, and is reflected again toward the image sensor 214. The light rays 290A-C travel different distances from the lens 210 to the image sensor 214. Thus, the in the embodiment shown, the micromirror array 217 and the intermediate mirrors 219A-D provide at least five paths for a given light ray to travel between the lens 210 and the image sensor 214.

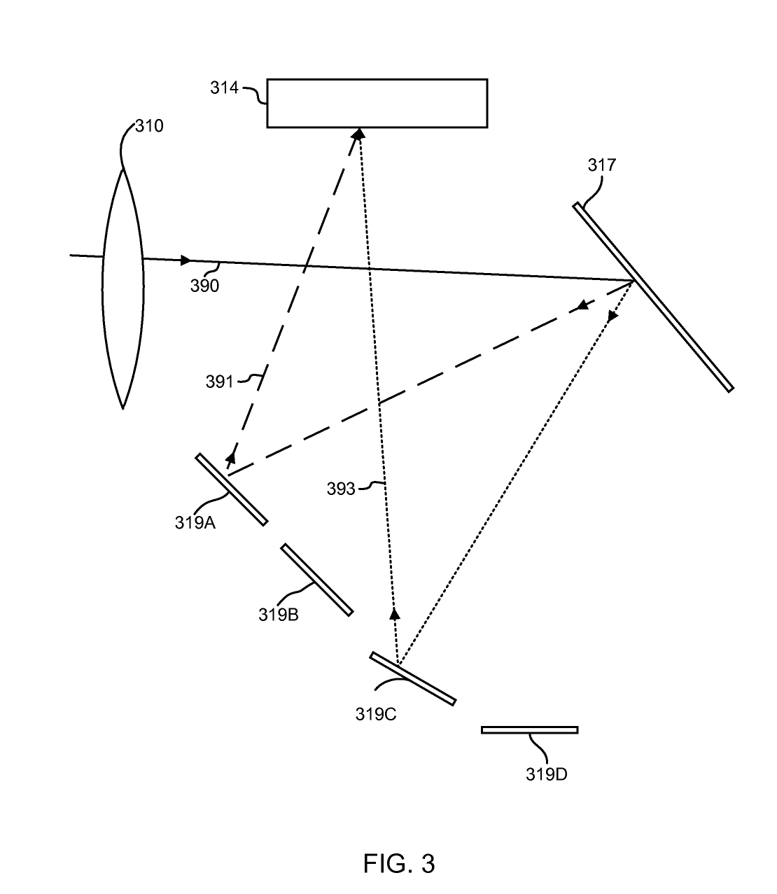

FIG. 3 illustrates an embodiment of a system for varying the distance traveled by rays of light. The system includes a lens 310, a micromirror array 317, intermediate mirrors 319A-D, and an image sensor 314. The image sensor 314 is positioned on the opposite side of the lens 310 as the intermediate mirrors 319A-D. FIG. 3 also illustrates two of the paths 391, 393 that a light ray 390 can travel from the lens 310 to the image sensor 314. If the micromirror that reflects the light ray 390 is in a first position, the light ray 390 travels a first path 391 to the intermediate mirror 319A and then to the image sensor 314. If the micromirror that reflects the light ray 390 is in a second position, the light ray 390 travels a second path 393 to the intermediate mirror 319A and then to the image sensor 314. The micromirror may also be positioned to reflect light toward the other intermediate mirrors 319B, 319D.

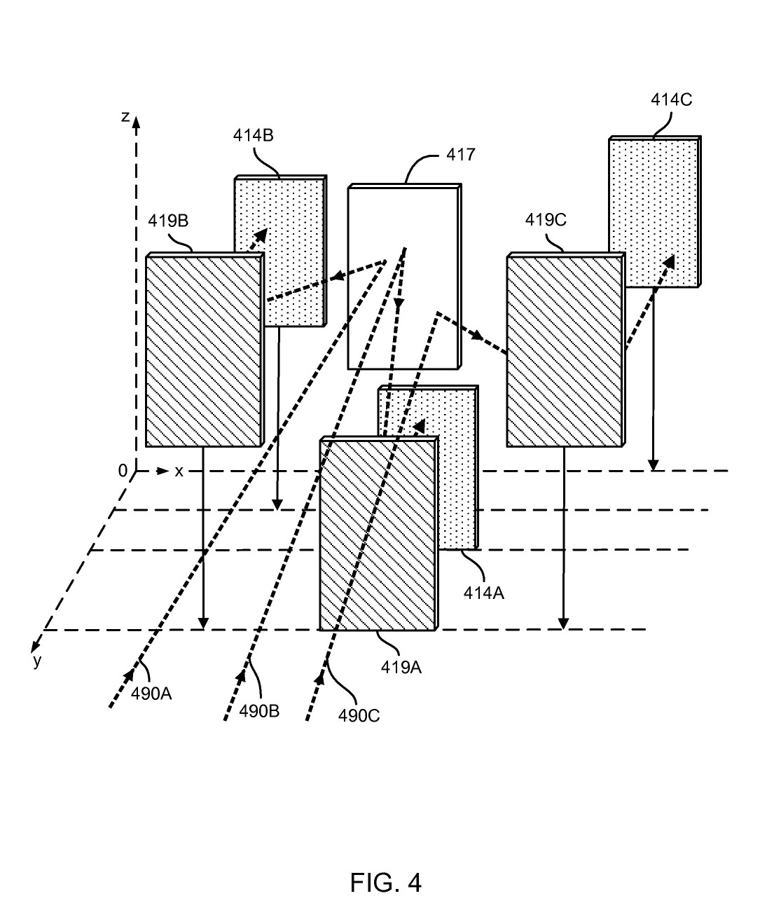

FIG. 4 illustrates an embodiment of a system for varying the distance traveled by rays of light. The system includes a micromirror array 417, intermediate mirrors 419A-C, and image sensors 414A-C. The micromirrors in the micromirror array 417 can be rotated on at least 2 axes. The intermediate mirrors 419A-C lie on approximately the same plane as one another. Image sensor 414A lies on a plane closest to the plane of the intermediate mirrors relative to image sensor 414B and image sensor 414C. Image sensor 414C lies on a plane furthest from the plane of the intermediate mirrors relative to image sensor 414A and image sensor 414B. The positions and orientations of the micromirror array 417, the intermediate mirrors 419A-C, and the image sensors 414A-C are illustrative. In other embodiments, the image sensors 414A-C may lay on the same plane and/or the intermediate mirrors 419A-C may lay on different planes, and the micromirror array 417, the image sensors 414 A-C, and the intermediate mirrors 419A-C may have different orientations than is shown in FIG. 4. Furthermore, other embodiments may include more or fewer intermediate mirrors and image sensors.

The micromirror array 17 can reflect a light ray in at least three directions, and each direction has a different distance that the light ray will travel from the micromirror array 17 to an image sensor 414A-C. For example, light ray 490A is reflected by the micromirror array 17 toward intermediate mirror 419B, which reflects the light ray 490A toward image sensor 414B. The distance traveled by the light ray 490A between the micromirror array 17 and the light sensor 4148 is different than the distance that light ray 490A would travel to an image sensor if the micromirror array 17 reflected light ray 490A toward intermediate mirror 419A or intermediate mirror 419C. Light ray 490B is reflected by the micromirror array 17 toward intermediate mirror 419A, which reflects the light ray 490B toward the image sensor 414A. The distance traveled by the light ray 490B between the micromirror array 17 and the light sensor 414A is different than the distance that light ray 490B would travel to an image sensor if the micromirror array 17 reflected light ray 490A toward intermediate mirror 4198 or intermediate mirror 419C. Finally, light ray 490C is reflected by the micromirror array 17 toward intermediate mirror 419C, which reflects the light ray 490C toward the image sensor 414C. The distance traveled by the light ray 490C between the micromirror array 17 and the light sensor 414C is different than the distance that light ray 490C would travel to an image sensor if the micromirror array 17 reflected light ray 490C toward intermediate mirror 419A or intermediate mirror 4198.

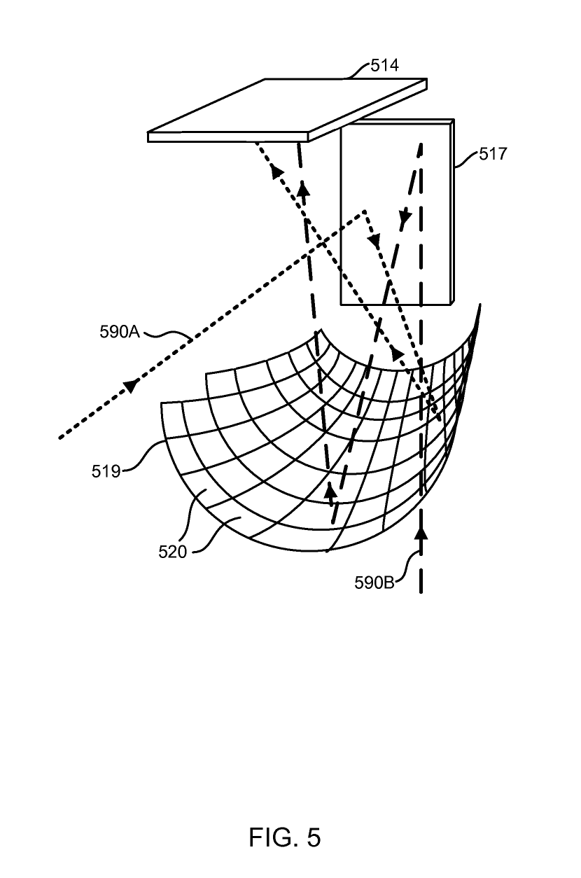

FIG. 5 illustrates an embodiment of a system for varying the distance traveled by rays of light. The system includes an image sensor 514, a micromirror array 517, and an intermediate mirror array 519 that includes a plurality of intermediate mirrors 520. The intermediate mirrors 520 may each have a different orientation and may not form a smooth surface. The number of intermediate mirrors 520 increases the number of different distances a light ray may travel between the micromirror array 517 and the image sensor 514. A micromirror in the micromirror array 517 may be positioned to reflect light toward at least some of the intermediate mirrors 520, which then reflect the light toward the image sensor 514. Each micromirror may be configured to reflect light toward a subset of the intermediate mirrors 520, and the corresponding subset of intermediate mirrors 520 may be oriented on the intermediate mirror array 519 to reflect light from the corresponding micromirrors toward the image sensor 514.

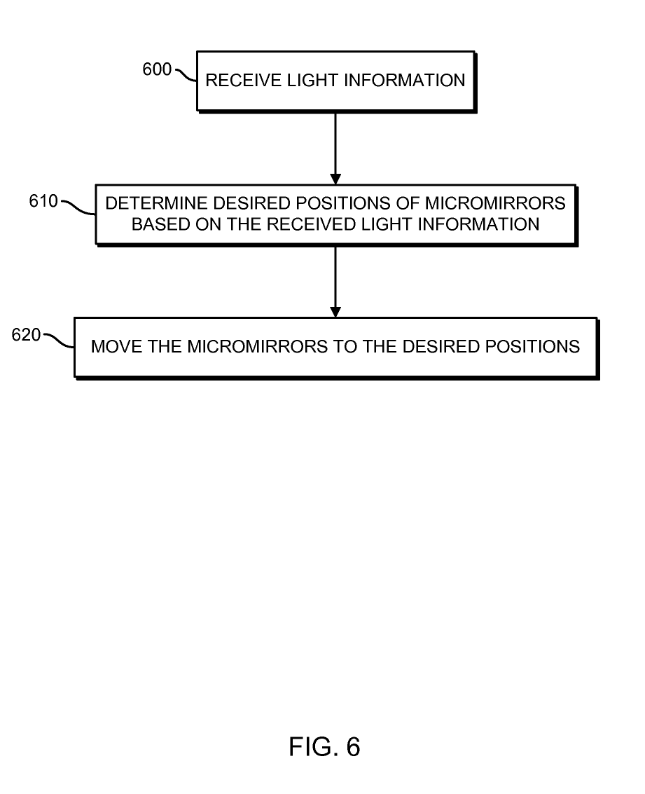

FIG. 6 is a block diagram that illustrates an embodiment of a method for positioning micromirrors. Other embodiments of this method and the other methods described herein may omit blocks, may add blocks, may change the order of the blocks, may combine blocks, and/or may divide blocks into separate blocks. Additionally, components of one or more devices for sensing light may implement the method shown in FIG. 6 and the other methods described herein.

In block 600, light information is received from one or more light sensors. The light sensors may include phase detection sensors and/or contrast measurement sensors, and the light information may indicate how focused the sensed light is on respective areas of the one or more light sensors. Additionally, light information may include depth information detected by the one or more light sensors. For example, the light sensors may use stereo vision or structured light to measure the distance from the one or more light sensors to different parts of a scene. Moving to block 610, desired positions of micromirrors are determined based on the received light information. The desired positions may be determined with the objective of improving the focus of the incident light on the respective areas of the light sensors. Also, micromirrors may be organized into sets of micromirrors, and all the micromirrors in a set may be positioned to reflect light toward the same intermediate mirror. The organization may be predetermined (e.g., the micromirrors may be organized into sets of 10, 15, 100, etc., micromirrors, which may or may not be adjacent), or the organization may take place dynamically (e.g., the micromirrors are grouped based on the received light information). Next, in block 620, the micromirrors are moved to the desired positions. For example, once the desired positions are determined, position data that indicates the desired positions may be sent to the micromirror array, and the micromirror array may move the micromirrors accordingly.

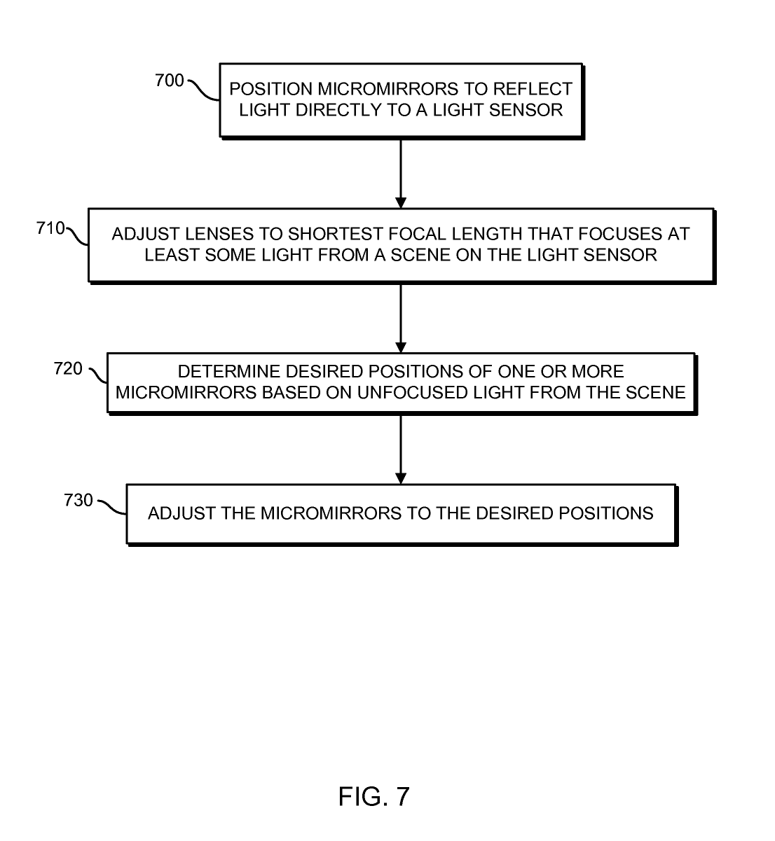

FIG. 7 is a block diagram that illustrates an embodiment of a method for positioning micromirrors. Beginning in block 700, micromirrors are positioned to reflect light from a scene directly toward a light sensor. Next, in block 710, lenses are adjusted to the shortest focal length that focuses at least some light from a scene on the light sensor. Proceeding to block 720, desired positions of one or micromirrors are determined based on the unfocused light from the scene. In one embodiment, the positions are be determined with the objective of making the unfocused light travel a longer distance to an image sensor, the longer distance being closer to a focal distance of the unfocused light. Finally, in block 730, the micromirrors are adjusted to the desired positions, and the readings of the light sensor may be recorded.

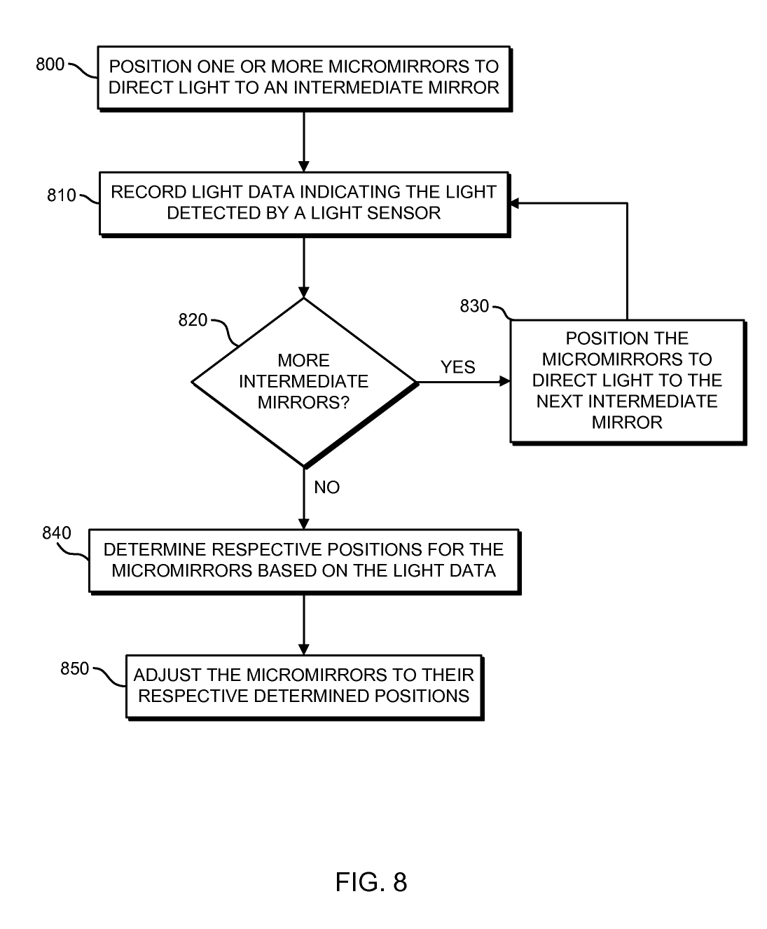

FIG. 8 is a block diagram that illustrates an embodiment of a method for positioning micromirrors. Beginning in block 800, one or more micromirrors are positioned to direct light toward an intermediate mirror, which reflects light toward a light sensor. Next, in block 810, light data indicating the light detected by the light sensor is recorded. The light incident to the light sensor includes the light reflect by the intermediate mirror. Moving to block 820, it is determined if there are more intermediate mirrors. If yes, the method proceeds to block 830, where the micromirrors are positioned to direct light to the next intermediate mirror, which reflects the light to the image sensor, and the method returns to block 810, where the light data is again recorded. If, in block 820, there are no more intermediate mirrors, the method proceeds to block 840, where respective positions are determined for the micromirrors based on the light data. The determination may include a comparison of the light data recorded while the micromirrors reflect light toward each of the intermediate mirrors and a selection of a position that corresponds to desired light properties (e.g., the light is more focused) on the light sensor. Finally, in block 850, the micromirrors are adjusted to their respective determined positions.

The above described systems and methods can be achieved by supplying one or more storage media having computer-executable instructions for realizing the above described operations to one or more imaging devices that are configured to read the computer-executable instructions stored in the one or more storage media and execute them. In this case, imaging devices perform the operations of the above-described embodiments when executing the computer-executable instructions read from the one or more storage media. Also, an operating system on the one or more imaging devices may carry out part or all of the actual processing that realizes the operations of the above described embodiments. Thus, the computer-executable instructions and/or the one or more storage media storing the computer-executable instructions therein constitute an embodiment.

Any applicable computer-readable storage medium (e.g., a magnetic disk (including a floppy disk and a hard disk), an optical disc (including a CD, a DVD, a Blu-ray disc), a magneto-optical disk, a magnetic tape, and a solid state drive (including flash memory, DRAM, SRAM) can be employed as a storage medium for the computer-executable instructions. The computer-executable instructions may be written to a computer-readable storage medium provided on a function-extension board inserted into the imaging device or on a function-extension unit connected to the imaging device, and a CPU provided on the function-extension board or unit may carry out part or all of the actual processing that realizes the operations of the above-described embodiments.

While the above disclosure describes illustrative embodiments, it is to be understood that the invention is not limited to the above disclosure. To the contrary, the invention covers various modifications and equivalent arrangements within the spirit and scope of the appended claims.

What is claimed is:

1. A device for sensing light, the device comprising:
a light sensor;
one or more intermediate mirrors;
a micromirror array including a plurality of independently positionable micromirrors, wherein a first micromirror in the micromirror array is positionable in a first position such that light reflected by the first micromirror while in the first position is reflected toward a first region on one of the one or more intermediate mirrors, wherein the light reflected toward the first region on one of the one or more intermediate mirrors is further reflected to the light sensor; and
a lens configured to direct light toward the micromirror array.

2. A device of claim 1, wherein a second micromirror in the micromirror array is positionable in a second position such that light reflected by the second micromirror while in the second position is reflected toward a second region on one of the one or more intermediate mirrors, wherein the light reflected toward the second region on one of the one or more intermediate mirrors is further reflected to the light sensor.

3. A device of claim 2, wherein the light reflected by the first micromirror while in the first position travels a different distance from the lens to the light sensor than the light reflected by the second micromirror while in the second position.

4. The device of claim 2, further comprising:
one or more processors configured to
compare a contrast in light signals at the light sensor while the first micromirror is positioned in the first position to a contrast in light signals at the light sensor while the first micromirror is positioned in the second position.

5. The device of claim 4, wherein the one or more processors are further configured to
compare a contrast in light signals at the light sensor while the first micromirror is positioned in a third position to the contrast in light signals at the light sensor while the first micromirror is positioned in the first position and the contrast in light signals at the light sensor while the first micromirror is positioned in the second position, wherein in the third position light is reflected from the first micromirror toward a third region on one or of the one or more intermediate mirrors and further reflected to the light sensor.

6. The device of claim 1, further comprising:
an array of phase-detect focus sensors, and
one or more processors configured to cause the device to perform a focus sweep, the focus sweep including adjusting a position of the lens through a range of positions and receiving signals from the array of phase-detect focus sensors corresponding to respective positions of the lens.

7. The device of claim 1, wherein a micromirror in the plurality of independently positionable micromirrors is rotatably positionable on at least one axis.

8. The device of claim 1, wherein a micromirror in the plurality of independently positionable micromirrors is translationably positionable on at least one axis.

9. A method for sensing light, the method comprising:
positioning a first micromirror in an array of micromirrors such that light reflected from the first micromirror travels a first path from the first micromirror to a first intermediate mirror to a light sensor; and
positioning a second micromirror in the array of micromirrors such that light reflected from the second micromirror travels a second path from the second micromirror to a second intermediate mirror to the light sensor.

10. The method of claim 9, wherein
the light reflected from the first micromirror and the second micromirror is received from a lens;
the light reflected from the first micromirror travels a first distance from the lens to the first micromirror to the first intermediate mirror to the light sensor, wherein the first distance is substantially equal to a focal distance of the light reflected from the first micromirror; and
the light reflected from the second micromirror travels a second distance from the lens to the second micromirror to the second intermediate mirror to the light sensor, wherein the second distance is substantially equal to a focal distance of the light reflected from the second micromirror.

11. The method of claim 9, wherein positioning the first micromirror includes rotating the first micromirror on at least one axis.

12. The method of claim 9, wherein positioning the first micromirror includes translating the first micromirror on at least one axis.

13. A device for sensing light, the device comprising:
a light sensor;
one or more intermediate surfaces, wherein an intermediate surface includes a reflective surface; and
a plurality of micromirrors, each micromirror including a reflective surface and being positionable in at least a first position and a second position, wherein in the first position light reflected by a first micromirror travels a first path from the first micromirror to a first region on the light sensor, and wherein in the second position light reflected by the first micromirror travels a second path from the first micromirror to a first intermediate surface to the first region on the light sensor.

14. The device of claim 13, wherein each micromirror is positionable in a third position, wherein in the third position light reflected by the first micromirror travels a third path from the first micromirror to a second intermediate surface to the first region on the light sensor.

15. The device of claim 13, wherein in the first position light reflected by a second micromirror travels a fourth path from the second micromirror to a second region on the light sensor, and wherein in the second position light reflected by the second micromirror travels a fifth path from the second micromirror to the first intermediate surface to the second region on the light sensor.
